(19) United States
(12) Patent Application Publication
(10) Pub. No.: US 2025/0242552 A1
(43) Pub. Date: Jul. 31, 2025

(54) EXPANDABLE PALLET FOR FORMING A COMPOSITE STRUCTURE

(71) Applicant: The Boeing Company, Arlington, VA (US)

(72) Inventor: Richard Alexander Prause, Charleston, SC (US)

(21) Appl. No.: 18/424,352

(22) Filed: Jan. 26, 2024

(51) Int. Cl. B29C 70/34; B29C 33/30; B29L 31/30

(52) U.S. Cl. CPC B29C 70/342; B29C 33/308; B29L 2031/3076

(57) ABSTRACT

The illustrative examples present an expandable pallet and methods for forming a composite structure. The expandable pallet comprises a first pallet half having a vacuum holding zone positioned on an angled face of the first pallet half; and a second pallet half movable relative to the first pallet half to expand a recess between the first pallet half and the second pallet half for forming the composite structure, the recess comprising the angled face of the first pallet half.

### STATEMENT OF GOVERNMENT INTEREST

This invention was made with Government Support under Contract No. 80NSSC22M0152 PWP NGT GEN awarded by NASA. The Government has certain rights in the invention.

### BACKGROUND INFORMATION

### 1. Field

The present disclosure relates generally to forming composite structures and more specifically to an expandable pallet for forming a composite structure.

### 2. Background

Current aircraft designs use various components, such as stringers, to resist bending, torsional, shear, and direct loads along the fuselage of the aircraft. Stringers can be formed from lightweight composites. Composite materials include a tape or a fabric with fibers embedded into a resin matrix. A composite layup is processed using a forming tool to define the stringer shape. However, supporting composite layups in forming tools has been challenging. Processing time for forming the stringer shape into the composite layup can be undesirably high.

Therefore, it would be desirable to have a method and apparatus that takes into account at least some of the issues discussed above, as well as other possible issues. For example, it would be desirable to present a method and apparatus to reduce the time for forming a composite material into a stringer shape.

### SUMMARY

An embodiment of the present disclosure provides an expandable pallet for forming a composite structure. The expandable pallet comprises a first pallet half having a vacuum holding zone positioned on an angled face of the first pallet half, and a second pallet half movable relative to the first pallet half to expand a recess between the first pallet half and the second pallet half for forming the composite structure. The recess comprises the angled face of the first pallet half.

Another embodiment of the present disclosure provides a method of forming a composite structure. A laminated charge is applied onto an expandable pallet comprising a first pallet half and a second pallet half. The first pallet half has a vacuum holding zone positioned on an angled face of the first pallet half. The laminated charge is progressively formed into a recess defined by the expandable pallet using a plurality of rollers, including forming the laminated charge against the angled face. At least one of the first pallet half or the second pallet half of the expandable pallet is moved away from the other of the first pallet half or the second pallet half of the expandable pallet during the progressively forming of the laminated charge to expand the recess. Vacuum is applied to the vacuum holding zone to hold the laminated charge against the angled face during the progressive forming of the laminated charge.

Yet another embodiment of the present disclosure provides a method of forming a composite structure. A laminated charge is applied onto an expandable pallet. The laminated charge is progressively formed into an expanding recess between a first pallet half and a second pallet half of the expandable pallet using a plurality of rollers. The laminated charge is held against the first pallet half of the expandable pallet by drawing vacuum in a first vacuum holding zone in an angled face of the first pallet half as the plurality of rollers progressively form the laminated charge.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of an isometric view of a composite structure on an expandable pallet in accordance with an illustrative embodiment;

FIG. 4 is an illustration of a front view of a composite material on an expandable pallet in a closed form in accordance with an illustrative embodiment;

FIG. 5 is an illustration of a cross-sectional front view of a composite material on an expandable pallet in an open form in accordance with an illustrative embodiment;

FIG. 6 is an illustration of a front view of a composite material on an expandable pallet in an open form with a support in accordance with an illustrative embodiment;

FIG. 7 is an illustration of an isometric view of one half of an expandable pallet in accordance with an illustrative embodiment;

FIG. 8 is an illustration of an isometric view of an expandable pallet with vacuum connections in accordance with an illustrative embodiment;

FIG. 9 is an illustration of a side view of a plurality of rollers and an expandable pallet in accordance with an illustrative embodiment;

FIG. 10 is a flowchart of a method of forming a composite structure in accordance with an illustrative embodiment;

FIG. 11 is a flowchart of a method of forming a composite structure in accordance with an illustrative embodiment;

FIG. 12 is an illustration of an aircraft manufacturing and service method in a form of a block diagram in accordance with an illustrative embodiment; and

FIG. 13 is an illustration of an aircraft in a form of a block diagram in which an illustrative embodiment may be implemented.

### DETAILED DESCRIPTION

The illustrative examples recognize and take into account that to build stringers in a faster manner, it may be desirable to reduce the forming time for a laminated charge. The illustrative examples recognize and take into account that dwell time is used in composite forming operations. The illustrative examples recognize and take into account that if a shorter forming/dwell time is used, a laminated charge can relax back toward a flat shape when the forming die is removed. The illustrative examples recognize and take into account that current dwell time during forming for a laminated charge can be undesirably long.

The illustrative examples provide an expandable pallet for forming a composite structure. The expandable pallet of the illustrative examples can be used to reduce forming time for composite structures such as stringers.

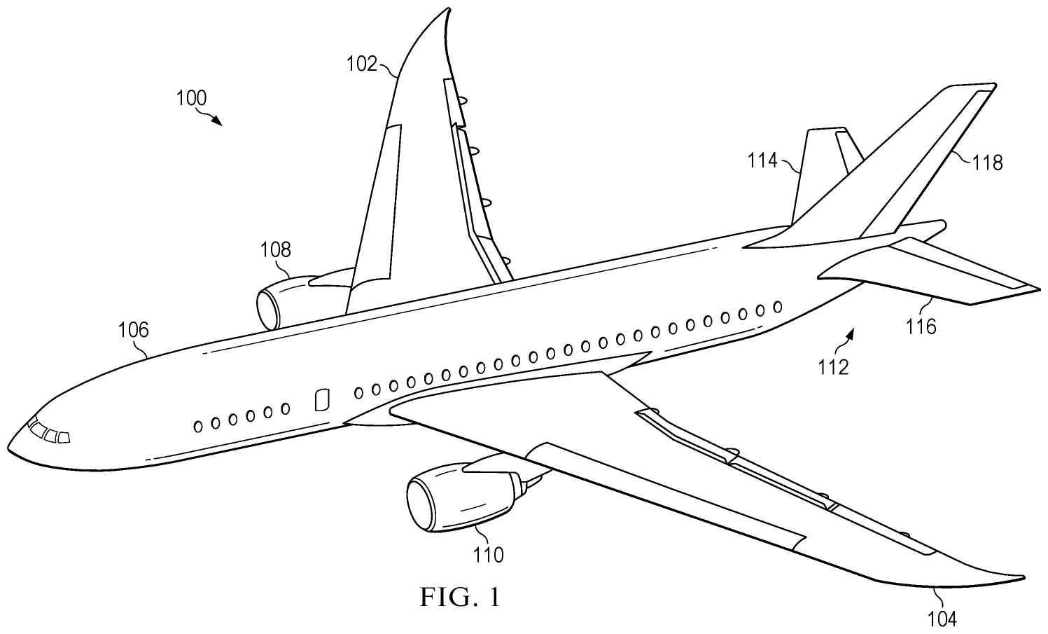

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite structures formed using the methods and expandable pallet of the illustrative examples. A composite structure formed using the methods and expandable pallet of the illustrative examples can be a part of at least one of wing 102, wing 104, body 106, horizontal stabilizer 114, horizontal stabilizer 116, or vertical stabilizer 118. For example, at least one stringer of body 106 of aircraft 100 can be formed using a method of the illustrative examples. As another example, at least one stringer of body 106 of aircraft 100 can be formed using an expandable pallet of the illustrative examples.

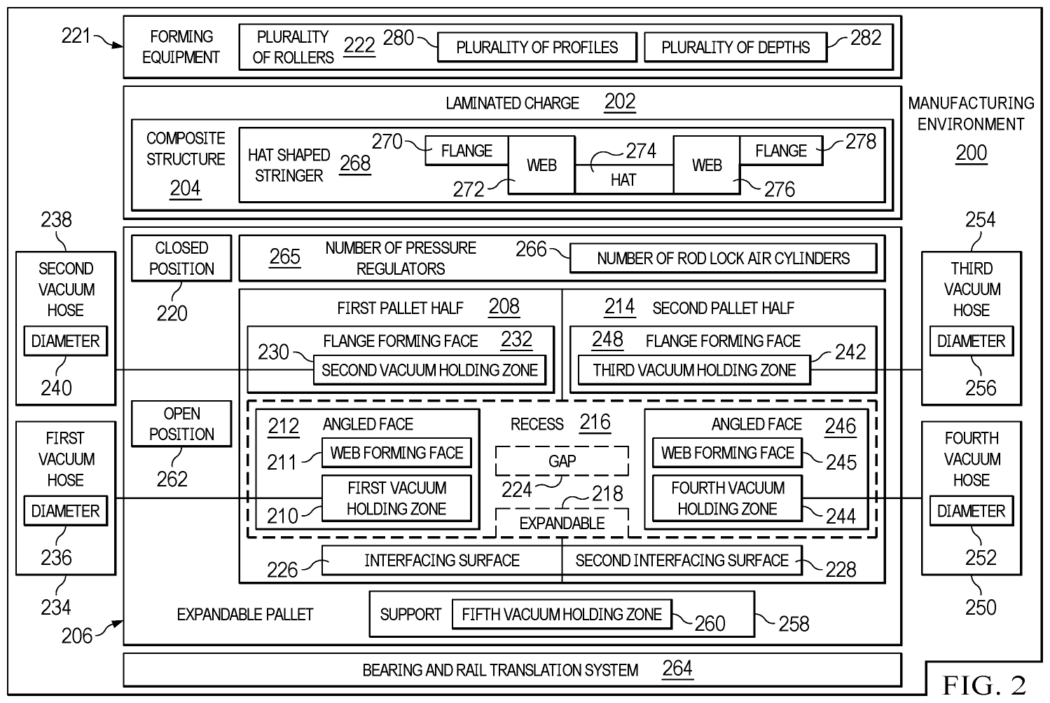

Turning now to FIG. 2, an illustration of a block diagram of a manufacturing environment is depicted in accordance with an illustrative embodiment. Laminated charge 202 can be formed into composite structure 204 using expandable pallet 206 in manufacturing environment 200.

Expandable pallet 206 comprises first pallet half 208 having first vacuum holding zone 210 positioned on angled face 212 of first pallet half 208. Second pallet half 214 is movable relative to first pallet half 208 to expand recess 216 between first pallet half 208 and second pallet half 214 for forming composite structure 204. Recess 216 comprises angled face 212 of first pallet half 208.

Recess 216 is expandable 218. Laminated charge 202 is applied to expandable pallet 206 while expandable pallet 206 is in closed position 220. Laminated charge 202 is progressively formed into recess 216 defined by expandable pallet 206 using forming equipment 221. Forming equipment 221 can take any desirable form. In some illustrative examples, forming equipment 221 comprises plurality of rollers 222.

In some illustrative examples, laminated charge 202 is progressively formed into recess 216 defined by expandable pallet 206 using plurality of rollers 222. At least one of first pallet half 208 or second pallet half 214 moves relative to the other of first pallet half 208 or second pallet half 214. In some illustrative examples, only one of first pallet half 208 or second pallet half 214 moves away from the other of first pallet half 208 or second pallet half 214 to increase gap 224 in recess 216. In some illustrative examples, first pallet half 208 and second pallet half 214 move away from each other to increase gap 224 in recess 216.

The at least one of first pallet half 208 or second pallet half 214 moves relative to the other of first pallet half 208 or second pallet half 214 due to the forming equipment 221 progressively forming laminated charge 202 into recess 216. The incrementally changing forming equipment 221 pushes at least one of first pallet half 208 or second pallet half 214 relative to the other of first pallet half 208 or second pallet half 214. In some illustrative examples, first pallet half 208 and second pallet half 214 are pushed away from each other by forming equipment 221 as forming equipment 221 progressively forms laminated charge 202 into recess 216. First pallet half 208 and second pallet half 214 are spread apart by forming equipment 221.

In some illustrative examples, gap 224 is not present in recess 216 in closed position 220. In some illustrative examples, interfacing surface 226 of first pallet half 208 is in contact with second interfacing surface 228 of second pallet half 214 in closed position 220. In these illustrative examples, as plurality of rollers 222 progressively form laminated charge 202 into recess 216, gap 224 between interfacing surface 226 and second interfacing surface 228 increases.

Plurality of rollers 222 is oriented in a serial configuration for progressively forming laminated charge 202 into recess 216 defined by expandable pallet 206. Recess 216 of expandable pallet 206 expands as plurality of rollers 222 progressively form laminated charge 202 into recess 216 in expandable pallet 206. In some illustrative examples, plurality of rollers 222 moves in a linear motion relative to expandable pallet 206 to urge laminated charge 202 into recess 216. In other illustrative examples, expandable pallet 206 moves in a linear motion relative to plurality of rollers 222. Plurality of rollers 222 shapes laminated charge 202 into at least part of a shape of composite structure 204.

As depicted, plurality of rollers 222 is arranged in a serial configuration. In some illustrative examples, each successive roller of the plurality of rollers 222 is progressively deeper than a preceding roller, and plurality of rollers 222 gradually press the laminated charge 202 into recess 216 such that each successive roller of plurality of rollers 222 presses laminated charge 202 deeper into recess 216. In some illustrative examples, each roller of plurality of rollers 222 has a different cross-sectional shape than each other roller of plurality of rollers 222 to press laminated charge 202 deeper than each previous roller of plurality of rollers 222. In these illustrative examples, plurality of rollers 222 has plurality of profiles 280 and plurality of depths 282. In other illustrative examples, each roller of plurality of rollers 222 is positioned a different height than each other roller of plurality of rollers 222 to orient each roller progressively deeper than a preceding roller. In these illustrative examples, plurality of rollers 222 can have the same profile but different mounting heights.

In some illustrative examples, first pallet half 208 comprises first vacuum holding zone 210 and second vacuum holding zone 230 controllable independently of first vacuum holding zone 210. In some illustrative examples, second vacuum holding zone 230 is configured to hold a portion of composite structure 204 different from a portion held by first vacuum holding zone 210. In one illustrative example, first vacuum holding zone 210 is present in angled face 212 while second vacuum holding zone 230 is positioned on flange forming face 232 of first pallet half 208.

In some illustrative examples, first vacuum holding zone 210 is configured to restrain laminated charge 202 from lifting off of expandable pallet 206 after forming. In some illustrative examples, the vacuum provided to first vacuum holding zone 210 is sufficient to maintain contact of laminated charge 202 on first pallet half 208. In some illustrative examples, vacuum provided to first vacuum holding zone 210 is configured to allow for movement of laminated charge 202 across first pallet half 208 during the progressive forming of laminated charge 202 into recess 216.

While at least one of first pallet half 208 or second pallet half 214 moves away from the other of first pallet half 208 and second pallet half 214, there is a ply slippage of laminated charge 202 towards recess 216 as recess 216 increases in size. Laminated charge 202 can be held against at least one of flange forming face 232, flange forming face 248, angled face 212, and angled face 246 to aid in controlling slippage over expandable pallet 206 by maintaining a desired tension through laminated charge 202.

Laminated charge 202 is formed into composite structure 204. In some illustrative examples, composite structure 204 takes the form of hat shaped stringer 268. Hat shaped stringer comprises flange 270, web 272, hat 274, web 276, and flange 278. First vacuum holding zone 210 keeps webs, web 272 and web 276, of hat shaped stringer 268 in place at the designed angle. By holding hat shaped stringer 268 in this configuration, it is held against relaxing (flattening out) so the web/flange and web/cap radii stay tight as well. Although hat shaped stringer 268 is depicted, composite structure 204 can have any desirable cross-sectional shape. In some illustrative examples, composite structure 204 takes the form of a T-shaped stringer. In some illustrative examples, composite structure 204 takes the form of a C-shaped stringer.

In some illustrative examples, second vacuum holding zone 230 is configured to restrain laminated charge 202 from lifting off of expandable pallet 206. In some illustrative examples, the vacuum provided to second vacuum holding zone 230 is sufficient to maintain contact of laminated charge 202 on first pallet half 208 before forming. In some illustrative examples, vacuum provided to second vacuum holding zone 230 is configured to allow for movement of laminated charge 202 across first pallet half 208 during the progressive forming of laminated charge 202 into recess 216.

When laminated charge 202 is flat and expandable pallet 206 is in closed position 220, second vacuum holding zone 230 holds laminated charge 202 against expandable pallet 206. Second vacuum holding zone 230 holds laminated charge 202 against expandable pallet 206 through the forming process.

As depicted, first vacuum holding zone 210 is controlled independently of second vacuum holding zone 230. As depicted, first vacuum hose 234 provides vacuum to first vacuum holding zone 210. First vacuum hose 234 is connected to first pallet half 208 to provide vacuum to first vacuum holding zone 210. First vacuum hose 234 has diameter 236.

As depicted, second vacuum hose 238 provides vacuum to second vacuum holding zone 230. Second vacuum hose 238 is connected to first pallet half 208 to provide vacuum to second vacuum holding zone 230. Second vacuum hose 238 has diameter 240. In some illustrative examples, diameter 236 of first vacuum hose 234 is smaller than diameter 240 of second vacuum hose 238. In some illustrative examples, diameter 236 of first vacuum hose 234 is smaller than diameter 240 of second vacuum hose 238 due to a surface area of first vacuum holding zone 210 being smaller than second vacuum holding zone 230.

In this illustrative example, second pallet half 214 has third vacuum holding zone 242 and fourth vacuum holding zone 244 controllable independently of third vacuum holding zone 242. As depicted, fourth vacuum holding zone 244 is positioned on angled face 246 of second pallet half 214. In this illustrative example, third vacuum holding zone 242 is present on flange forming face 248 of second pallet half 214.

As depicted, fourth vacuum holding zone 244 is controlled independently of third vacuum holding zone 242. As depicted, fourth vacuum hose 250 provides vacuum to fourth vacuum holding zone 244. Fourth vacuum hose 250 is connected to second pallet half 214 to provide vacuum to fourth vacuum holding zone 244. Fourth vacuum hose 250 has diameter 252.

As depicted, third vacuum hose 254 provides vacuum to third vacuum holding zone 242. Third vacuum hose 254 is connected to second pallet half 214 to provide vacuum to third vacuum holding zone 242. Third vacuum hose 254 has diameter 256. In some illustrative examples, diameter 252 of fourth vacuum hose 250 is smaller than diameter 256 of third vacuum hose 254. In some illustrative examples, diameter 252 of fourth vacuum hose 250 is smaller than diameter 256 of third vacuum hose 254 due to a surface area of fourth vacuum holding zone 244 being smaller than third vacuum holding zone 242.

In this illustrative example, first vacuum holding zone 210 forms a first web portion of a stringer, web 272 of hat shaped stringer 268, and fourth vacuum holding zone 244 forms a second web portion of the stringer, web 276 of hat shaped stringer 268. Flange forming face 232 is configured to form flange 270. Second vacuum holding zone 230 holds laminated charge 202 against flange forming face 232. When laminated charge 202 has been formed into composite structure 204, flange 270 is held against second vacuum holding zone 230.

Angled face 212 is configured to form web 272. Angled face 212 can be referred to as web forming face 211. First vacuum holding zone 210 holds laminated charge 202 against angled face 212. When laminated charge 202 has been formed into composite structure 204, web 272 is held against first vacuum holding zone 210. First vacuum holding zone 210 can reduce a dwell time for hat shaped stringer 268 without undesirably affecting hat shaped stringer 268. First vacuum holding zone 210 can maintain contact between composite structure 204 and first pallet half 208 after plurality of rollers 222 have formed composite structure 204.

First pallet half 208 comprises interfacing surface 226 and second pallet half 214 comprises second interfacing surface 228. Interfacing surface 226 and second interfacing surface 228 can be in contact with each other when expandable pallet 206 is in closed position 220. In some illustrative examples, a gap is present between interfacing surface 226 and second interfacing surface 228 in closed position 220, and alignment feature is present and in contact with interfacing surface 226 and second interfacing surface 228. When expandable pallet 206 is in open position 262, laminated charge 202 has been formed into composite structure 204. Expandable pallet 206 is locked in open position 262 by number of pressure regulators 265. Number of pressure regulators 265 can take any desirable form. In some illustrative examples, number of pressure regulators 265 takes the form of number of rod lock air cylinders 266. Number of pressure regulators 265 can be associated with at least one of first pallet half 208 or second pallet half 214. Number of pressure regulators 265 is connected to at least one of first pallet half 208 or second pallet half 214 and is configured to resist outward movement during forming and lock in place when forming of laminated charge 202 is complete. Number of pressure regulators 265 provides precise pressure to resist outward movement during forming. Number of pressure regulators 265 also locks in place when forming is complete. By locking in a final stringer shape position, further work can be performed on composite structure 204. The further work can include assembling stringer tooling and components such as a bladder, radius filler, and assembly compaction devices. In some illustrative examples, number of pressure regulators 265 pushes expandable pallet 206 together to reset for the next form cycle.

During forming, the force applied by forming equipment 221 is greater than the force applied by number of pressure regulators 265. The force applied by forming equipment 221 results in movement of at least one of first pallet half 208 or second pallet half 214 to increase the size of recess 216.

First pallet half 208 and second pallet half 214 can be moved relative to each other using any desirable translation system. In some illustrative examples, first pallet half 208 and second pallet half 214 are movably connected to bearing and rail translation system 264. Bearing and rail translation system 264 allows for expandable pallet 206 to be more precisely aligned and manipulated.

In some illustrative examples, support 258 can be present to support portions of laminated charge 202 above gap 224 between expandable pallet 206. In some illustrative examples, support 258 is movable in between first pallet half 208 and second pallet half 214. Support 258 is configured to contact a portion of laminated charge 202 extending between first pallet half 208 and second pallet half 214. In some illustrative examples, support 258 is configured to contact hat 274 of hat shaped stringer 268. In some illustrative examples, fifth vacuum holding zone 260 is present in support 258, and fifth vacuum holding zone 260 is independently controllable.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, support 258 is optional. In some illustrative examples, support 258 can be provided without fifth vacuum holding zone 260.

As another example, although plurality of rollers 222 is depicted, any desirable forming equipment can be used in conjunction with expandable pallet 206. In some illustrative examples, forming equipment 221 can comprise at least one of a punch or a conveyor. Punches can have expanding sizes and cross-sectional shapes similar to plurality of rollers 222. A conveyor could be used to move expandable pallet 206.

As yet another example, an alignment feature can be present between interfacing surface 226 and second interfacing surface 228. In these illustrative examples, the alignment feature enables expandable pallet 206 to be in closed position 220 without placing interfacing surface 226 and second interfacing surface 228 in contact. In some illustrative examples, the alignment feature is present and interfacing surface 226 and second interfacing surface 228 are in contact in closed position 220.

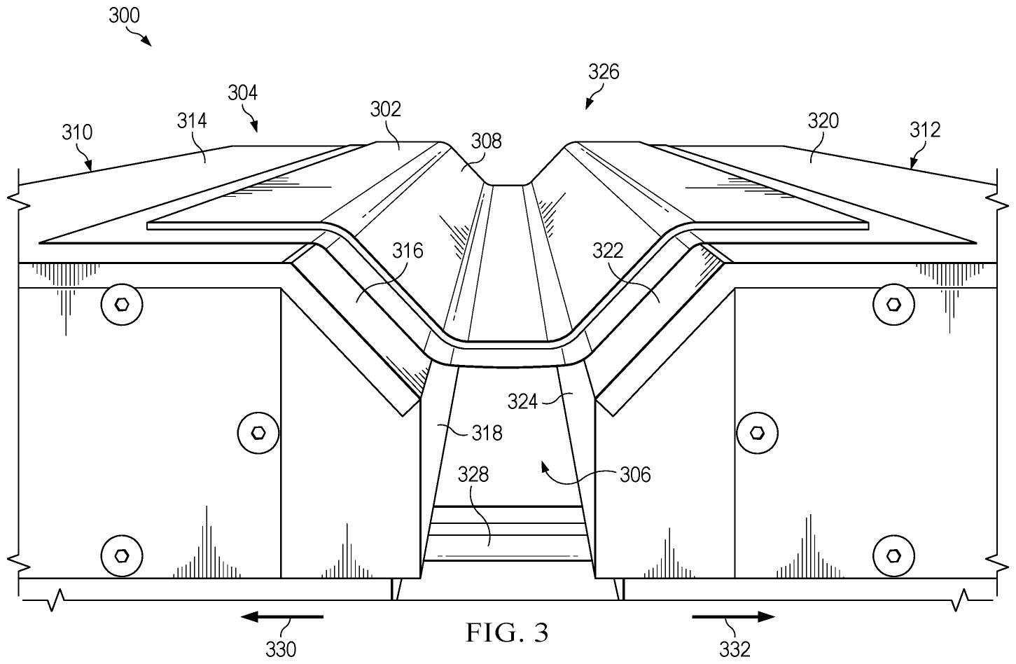

Turning now to FIG. 3, an illustration of an isometric view of a composite structure on an expandable pallet is depicted in accordance with an illustrative embodiment. In view 300, composite structure 302 is present on expandable pallet 304. Expandable pallet 304 is a physical implementation of expandable pallet 206 of FIG. 2.

In view 300, composite structure 302 takes the form of hat shaped stringer 308. In this illustrative example, expandable pallet 304 comprises first pallet half 310 and second pallet half 312. Recess 306 is present between first pallet half 310 and second pallet half 312. First pallet half 310 has flange forming surface 314, angled face 316, and interfacing surface 318. Second pallet half 312 has flange forming surface 320, angled face 322, and second interfacing surface 324. As depicted, expandable pallet 304 is in open position 326. Open position 326 is a final position for forming hat shaped stringer 308.

As depicted, first pallet half 310 and second pallet half 312 are on bearing and rail translation system 328. In this illustrative example, during progressive forming of composite structure 302, first pallet half 310 is moved in direction 330 away from second pallet half 312. In this illustrative example, during progressive forming of composite structure 302, second pallet half 312 is moved in direction 332 away from first pallet half 310.

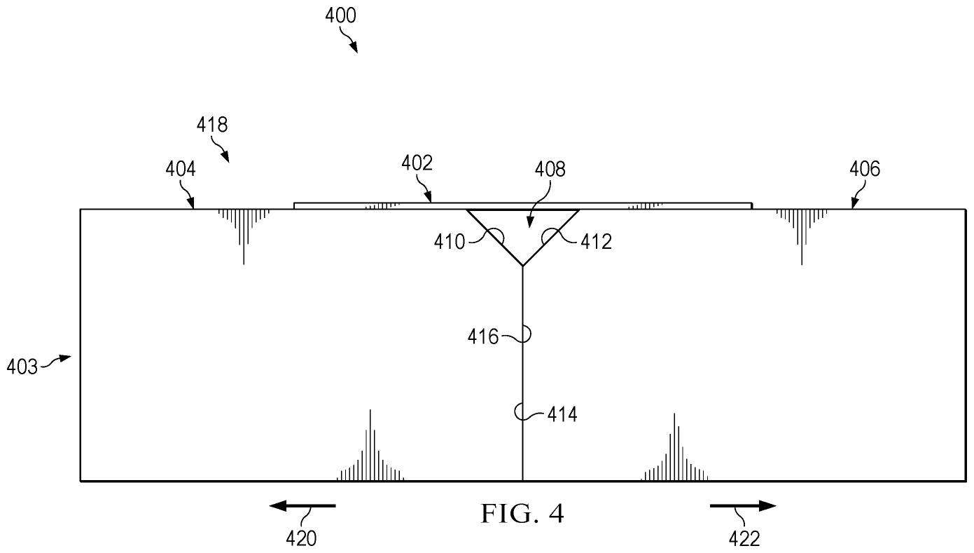

Turning now to FIG. 4, an illustration of a front view of a composite material on an expandable pallet in a closed form is depicted in accordance with an illustrative embodiment. In view 400, laminated charge 402 is present on expandable pallet 403. Expandable pallet 403 is a physical implementation of expandable pallet 206 of FIG. 2. In some illustrative examples, expandable pallet 403 can be the same as expandable pallet 304 of FIG. 3.

In view 400, laminated charge 402 is present on expandable pallet 403. Expandable pallet 403 comprises first pallet half 404 and second pallet half 406. Recess 408 is present between first pallet half 404 and second pallet half 406. Recess 408 is formed by angled face 410 of first pallet half 404 and angled face 412 of second pallet half 406. As depicted, expandable pallet 403 is in closed position 418. In closed position 418, first pallet half 404 is in contact with second pallet half 406.

As depicted, interfacing surface 414 of first pallet half 404 is in contact with second interfacing surface 416 of second pallet half 406 in closed position 418. During progressive forming of laminated charge 402 into recess 408, laminated charge 402 will be formed onto angled face 410 and angled face 412. During progressive forming of laminated charge 402 into recess 408, recess 408 will expand.

In other non-depicted examples, a slight gap can be present between interfacing surface 414 of first pallet half 404 and second interfacing surface 416 of second pallet half 406 in closed position 418. In some non-depicted examples, a center alignment structure can be present to align first pallet half 404 and second pallet half 406 in closed position 418. The center alignment structure can be in contact with first pallet half 404 and second pallet half 406 in closed position 418. In some illustrative examples, a significant gap can be present between interfacing surface 414 of first pallet half 404 and second interfacing surface 416 of second pallet half 406 in closed position 418.

In some illustrative examples, during progressive forming of laminated charge 402 into recess 408, first pallet half 404 is moved in direction 420 away from second pallet half 406. In some illustrative examples, during progressive forming of laminated charge 402 into recess 408, second pallet half 406 is moved in direction 422 away from first pallet half 404.

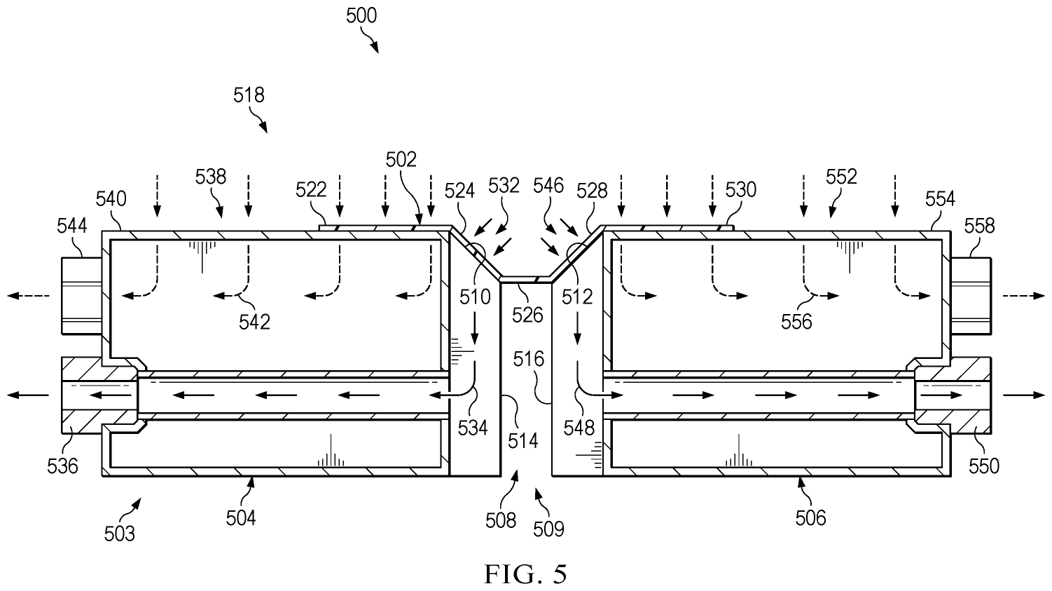

Turning now to FIG. 5, an illustration of a cross-sectional front view of a composite material on an expandable pallet in an open form is depicted in accordance with an illustrative embodiment. In view 500, laminated charge 502 is present on expandable pallet 503. Expandable pallet 503 is a physical implementation of expandable pallet 206 of FIG. 2. In some illustrative examples, expandable pallet 503 is the same as expandable pallet 304 of FIG. 3. In some illustrative examples, expandable pallet 503 is the same as expandable pallet 403 of FIG. 4.

In view 500, expandable pallet 503 is in open position 518. In open position 518, recess 508 between first pallet half 504 and second pallet half 506 comprises gap 509 between first pallet half 504 and second pallet half 506. Gap 509 is between interfacing surface 514 and second interfacing surface 516.

In view 500, laminated charge 502 has been formed against expandable pallet 503 into composite structure 520. Composite structure 520 has a hat shaped cross-section including flange 522, web 524, hat 526, web 528, and flange 530. Composite structure 520 is held against first pallet half 504 by first vacuum holding zone 532 and second vacuum holding zone 538. Composite structure 520 is held against second pallet half 506 by third vacuum holding zone 552 and fourth vacuum holding zone 546.

Vacuum path 534 from vacuum port 536 to angled face 510 provides vacuum to first vacuum holding zone 532. Vacuum path 542 from vacuum port 544 to surface 540 provides vacuum to second vacuum holding zone 538. As depicted, vacuum path 534 is separate from vacuum path 542. The vacuum provided to first vacuum holding zone 532 is controlled separately from the vacuum provided to second vacuum holding zone 538.

Vacuum path 548 from vacuum port 550 to angled face 512 provides vacuum to fourth vacuum holding zone 546. Vacuum path 556 from vacuum port 558 to surface 554 provides vacuum to third vacuum holding zone 552. As depicted, vacuum path 548 is separate from vacuum path 556. The vacuum provided to first vacuum holding zone 532 is controlled separately from the vacuum provided to second vacuum holding zone 538.

In other non-depicted examples, vacuum can be supplied to first vacuum holding zone 532 and second vacuum holding zone 538 through a single vacuum path. In some non-depicted examples, first vacuum holding zone 532 and second vacuum holding zone 538 are supplied by the same vacuum port. In some non-depicted examples, vacuum can be supplied to third vacuum holding zone 552 and fourth vacuum holding zone 546 through a single vacuum path. In some non-depicted examples, third vacuum holding zone 552 and fourth vacuum holding zone 546 are supplied by the same vacuum port.

In view 500, hat 526 is not supported by tooling. As depicted, hat 526 extends over gap 509. In some non-depicted examples, at least one of a vacuum bag or other flexible film can be present beneath hat 526 to provide support to hat 526.

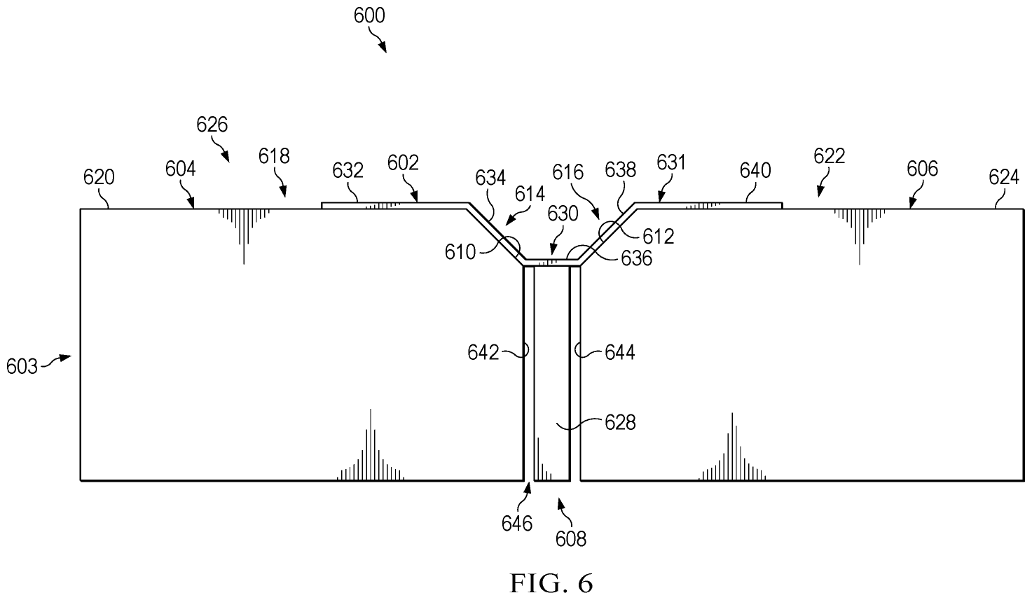

Turning now to FIG. 6, an illustration of a front view of a composite material on an expandable pallet in an open form with a support is depicted in accordance with an illustrative embodiment. In view 600, laminated charge 602 is present on expandable pallet 603. Expandable pallet 603 is a physical implementation of expandable pallet 206 of FIG. 2. In some illustrative examples, expandable pallet 603 is the same as expandable pallet 304 of FIG. 3. In some illustrative examples, expandable pallet 603 is the same as expandable pallet 403 of FIG. 4.

In view 600, expandable pallet 603 is in open position 626. In open position 626, recess 608 between first pallet half 604 and second pallet half 606 comprises gap 646 between first pallet half 604 and second pallet half 606. Gap 646 is between interfacing surface 642 and second interfacing surface 644.

In view 600 support 628 is present within gap 646. Support 628 is present to contact portions of laminated charge 602 extending over gap 646. In some illustrative examples, support 628 is movable in between first pallet half 604 and second pallet half 606 and is configured to contact a portion of laminated charge 602 extending between first pallet half 604 and second pallet half 606. In some illustrative examples, when support 628 is present under expandable pallet 603 when expandable pallet 603 is in a closed position.

In view 600, laminated charge 602 has been formed into composite structure 631 having a hat-shaped cross-section. Laminated charge 602 has flange 632, web 634, hat 636, web 638, and flange 640. Flange 632 and web 634 are in contact with first pallet half 604. Flange 640 and web 638 are in contact with second pallet half 606. Hat 636 is in contact with support 628.

Expandable pallet 603 comprises first pallet half 604 having first vacuum holding zone 614 positioned on angled face 610 of first pallet half 604. Expandable pallet 603 also comprises second pallet half 606 movable relative to first pallet half 604 to expand recess 608 between first pallet half 604 and second pallet half 606 for forming composite structure 631. Recess 608 comprises angled face 610 of first pallet half 604.

In this illustrative example, first pallet half 604 comprises first vacuum holding zone 614 positioned on angled face 610 and second vacuum holding zone 618 controllable independently of first vacuum holding zone 614. In this illustrative example, second vacuum holding zone 618 is positioned on flange forming face 620 of first pallet half 604.

In this illustrative example, second pallet half has a third vacuum holding zone 622 and fourth vacuum holding zone 616 controllable independently of third vacuum holding zone 622. Fourth vacuum holding zone 616 is positioned on angled face 612 of second pallet half 606. In this illustrative example, first vacuum holding zone 614 forms a first web portion of a stringer, web 634, and fourth vacuum holding zone 616 forms a second web portion of the stringer, web 638. Third vacuum holding zone 622 is positioned on flange forming face 624 of second pallet half 606.

In some illustrative examples, a fifth vacuum holding zone is present in support 628. In this illustrative example, fifth vacuum holding zone 630 is present in support 628, and fifth vacuum holding zone 630 is independently controllable. In this illustrative example, fifth vacuum holding zone 630 is controlled independently of first vacuum holding zone 614, second vacuum holding zone 618, third vacuum holding zone 622, and fourth vacuum holding zone 616.

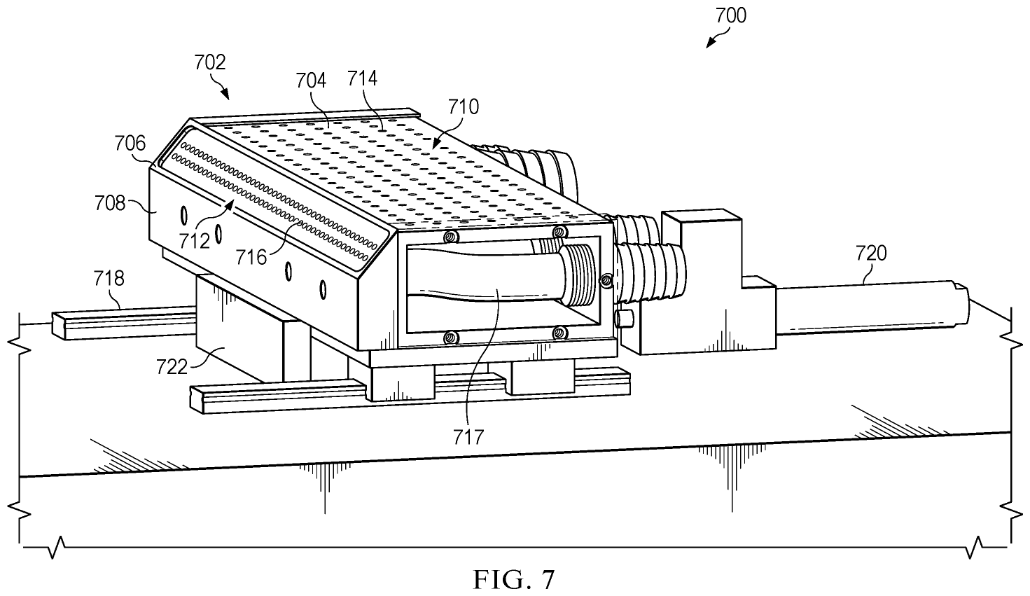

Turning now to FIG. 7, an illustration of an isometric view of one half of an expandable pallet is depicted in accordance with an illustrative embodiment. First pallet half 702 of an expandable pallet is present in view 700. First pallet half 702 can be a physical implementation of first pallet half 208 of FIG. 2.

First pallet half 702 has surface 704, angled face 706, and interfacing surface 708. Surface 704 and angled face 706 are configured to hold and form a composite material. In some illustrative examples, surface 704 can be referred to as a flange forming face. First vacuum holding zone 712 is on angled face 706. As depicted, first vacuum holding zone 712 comprises plurality of vacuum holes 716. Second vacuum holding zone 710 is on surface 704. As depicted, second vacuum holding zone 710 comprises plurality of vacuum holes 714. In some illustrative examples, first vacuum holding zone 712 and second vacuum holding zone 710 are independently controlled. As depicted, conduit 717 extends through first pallet half 702 to supply vacuum to first vacuum holding zone 712.

Although plurality of vacuum holes 714 is depicted in surface 704, any desirable vacuum distribution system can be provided for second vacuum holding zone 710. In some illustrative examples, a different size or quantity of vacuum holes can be present other than plurality of vacuum holes 714. In other illustrative examples, vacuum distribution channels can be present for second vacuum holding zone 710. In some illustrative examples, a porous material is present as surface 704 instead of plurality of vacuum holes 714 in second vacuum holding zone 710. In some illustrative examples, a porous material is present over and in addition to plurality of vacuum holes 714 in second vacuum holding zone 710.

Although plurality of vacuum holes 716 is depicted in angled face 706, any desirable vacuum distribution system can be provided for first vacuum holding zone 712. In some illustrative examples, a different size or quantity of vacuum holes can be present other than plurality of vacuum holes 716. In other illustrative examples, vacuum distribution channels can be present for first vacuum holding zone 712. In some illustrative examples, a porous material is present as angled face 706 instead of plurality of vacuum holes 716 in first vacuum holding zone 712. In some illustrative examples, a porous material is present over and in addition to plurality of vacuum holes 716 in first vacuum holding zone 712.

First pallet half 702 is movably connected to bearing and rail translation system 718. During forming of a laminated charge on first pallet half 702, first pallet half 702 moves along bearing and rail translation system 718 to change a size and shape of a recess between first pallet half 702 and a second pallet half (not depicted).

Respective pressure regulators are connected to first pallet half 702 and the second pallet half. In this illustrative example, the respective pressure regulator takes the form of rod lock air cylinder 720. Rod lock air cylinder 720 is connected to first pallet half 702. Rod lock air cylinder 720 can be used to control movement of first pallet half 702 and stop first pallet half 702 at a designated position.

As depicted, center alignment structure 722 is present to align first pallet half 702 and a second pallet half in a closed position. In this illustrative example, center alignment structure 722 allows portion of first pallet half 702 to be in contact with a second pallet half in a closed position. In this illustrative example, center alignment structure 722 allows interfacing surface 708 of first pallet half 702 to be in contact with a second interfacing surface of a second pallet half in a closed position.

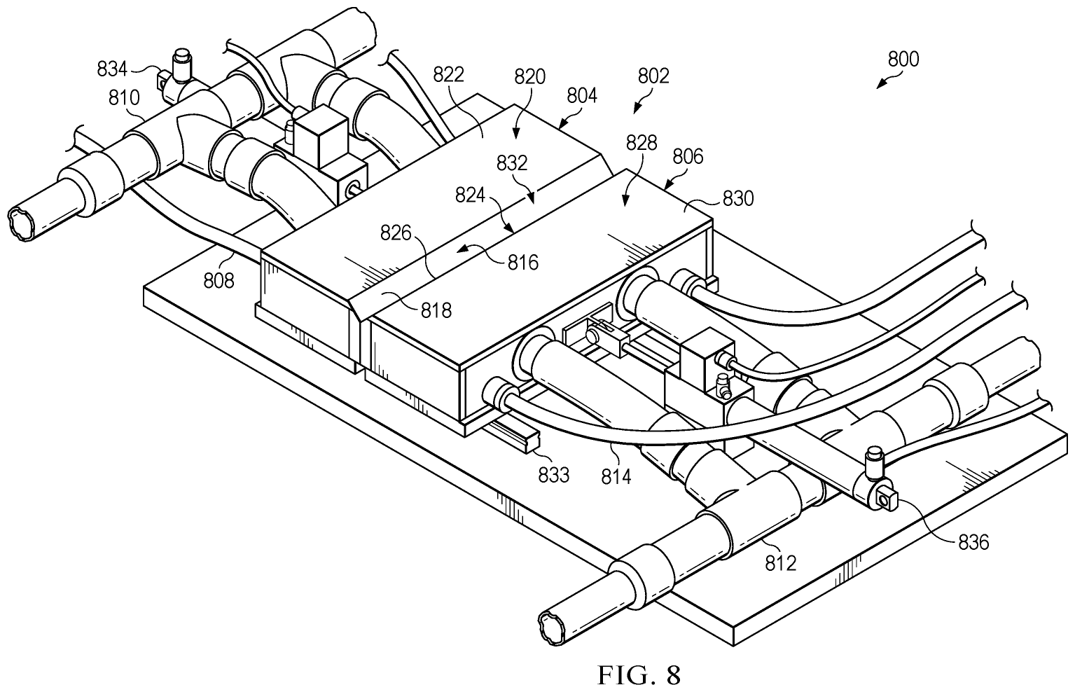

Turning now to FIG. 8, an illustration of an isometric view of an expandable pallet with vacuum connections is depicted in accordance with an illustrative embodiment. In view 800, expandable pallet 802 is shown with vacuum connections. Expandable pallet 802 comprises first pallet half 804 and second pallet half 806. First pallet half 804 is connected to first vacuum hose 808 and second vacuum hose 810. Second pallet half 806 is connected to third vacuum hose 812 and fourth vacuum hose 814.

First vacuum hose 808 provides vacuum to first vacuum holding zone 816 of first pallet half 804. First vacuum holding zone 816 is configured to hold a laminated charge against angled face 818 of first pallet half 804. Second vacuum hose 810 provides vacuum to second vacuum holding zone 820 of first pallet half 804. Second vacuum holding zone 820 is configured to hold a laminated charge against surface 822 of first pallet half 804.

As depicted, a diameter of first vacuum hose 808 is less than a diameter of second vacuum hose 810. The vacuum provided by first vacuum hose 808 is sufficient to hold a laminated charge against angled face 818 of first pallet half 804 during and after forming of the laminated charge against expandable pallet 802 and in expandable recess 832. Expandable recess 832 is formed between first pallet half 804 and second pallet half 806.

Third vacuum hose 812 provides vacuum to third vacuum holding zone 828 of second pallet half 806. Third vacuum holding zone 828 is configured to hold a laminated charge against surface 830 of second pallet half 806. Fourth vacuum hose 814 provides vacuum to fourth vacuum holding zone 824 of second pallet half 806. Fourth vacuum holding zone 824 is configured to hold a laminated charge against angled face 826 of second pallet half 806.

As depicted, expandable recess 832 is formed by angled face 818 and angled face 826. As at least one of first pallet half 804 or second pallet half 806 moves relative to the other on bearing and rail translation system 833, a gap is introduced between first pallet half 804 and second pallet half 806 within recess 832.

As depicted, each of first pallet half 804 and second pallet half 806 moves relative to each other. As depicted, each of first pallet half 804 and second pallet half 806 has a respective pressure regulator. In some illustrative examples, each of first pallet half 804 and second pallet half 806 has a respective rod lock air cylinder. First pallet half 804 is attached to rod lock air cylinder 834 to control movement of first pallet half 804 and stop first pallet half 804 at a designated position. Second pallet half 806 is attached to rod lock air cylinder 836 to control movement of first pallet half 804 and stop second pallet half 806 at a designated position. The designated positions provide for an open position of expandable pallet 802 that creates a desired cross-section of a composite structure. Although the pressure regulators take the form of rod lock air cylinder 834 and rod lock air cylinder 836, in other illustrative examples, the pressure regulators can take any desirable form.

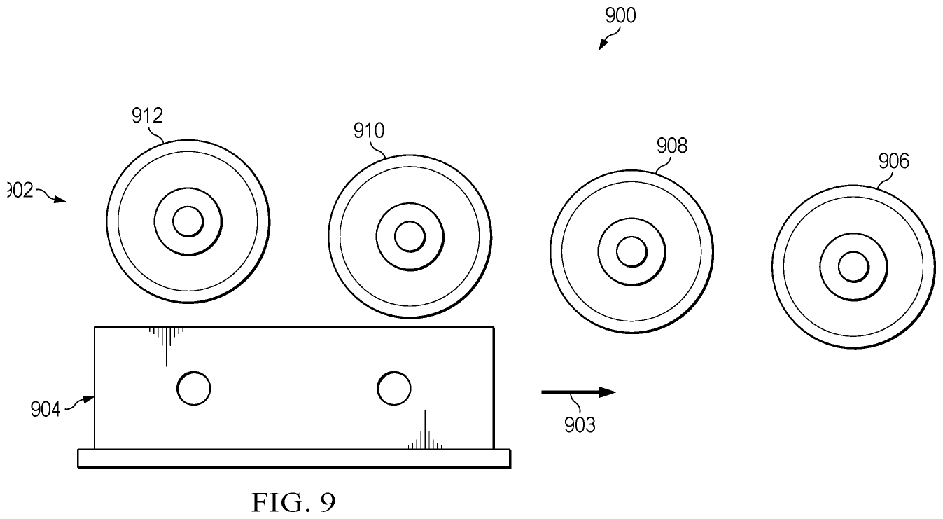

Turning now to FIG. 9, an illustration of a side view of a plurality of rollers and an expandable pallet is depicted in accordance with an illustrative embodiment. View 900 is a side view of plurality of rollers 902 relative to expandable pallet 904. Plurality of rollers 902 can be a physical implementation of plurality of rollers 222 of FIG. 2.

In view 900, plurality of rollers 902 is oriented in a serial configuration for progressively forming a laminated charge into a recess defined by expandable pallet 904. The recess of expandable pallet 904 expands as the plurality of rollers 902 progressively form the laminated charge into the recess in expandable pallet 904. In some illustrative examples, plurality of rollers 902 moves in a linear motion relative to expandable pallet 904 to urge the laminated charge into the recess. In other illustrative examples, expandable pallet 904 moves in a linear motion relative to plurality of rollers 902. Plurality of rollers 902 shapes the laminated charge into at least part of a shape of a composite structure, such as composite structure 204 of FIG. 2.

As depicted, plurality of rollers 902 is arranged in a serial configuration. In some illustrative examples, each successive roller of the plurality of rollers 902 is progressively deeper than a preceding roller, and the plurality of rollers 902 gradually press the laminated charge into the recess such that each successive roller of the plurality of rollers 902 presses the laminated charge deeper into the recess. In some illustrative examples, each roller of plurality of rollers 902 has a different cross-sectional shape than each other roller of plurality of rollers 902 to press the laminated charge is deeper than each previous roller of plurality of rollers 902. In other illustrative examples, each roller of plurality of rollers 902 is positioned a different height than each other roller of plurality of rollers 902 to orient each roller progressively deeper than a preceding roller.

In some illustrative examples, each roller of the plurality of rollers 902 is installed on a respective shaft. In some illustrative examples, plurality of rollers 902 can be motorized or independently driven. In some illustrative examples, plurality of rollers 902 are sent through expandable pallet 904 to form the laminated charge and expand the recess of expandable pallet 904 as plurality of rollers 902 move in linear direction 903 relative to expandable pallet 904.

In some illustrative examples, motion of plurality of rollers 902 is driven by contact with the laminated charge. In some illustrative examples, plurality of rollers 902 can spin passively due to contact with the laminated charge as the laminated charge moves in a linear motion underneath the plurality rollers 902. In these illustrative examples, the plurality of rollers 902 react to the linear motion of the expandable pallet 904 moving the laminated charge underneath the plurality of rollers 902 in linear direction 903.

As depicted, plurality of rollers 902 comprises four rollers, roller 906, roller 908, roller 910, and roller 912. In other non-depicted examples, there can be more than four rollers in plurality of rollers 902. In other non-depicted illustrative examples, there can be fewer than four rollers in plurality of rollers 902.

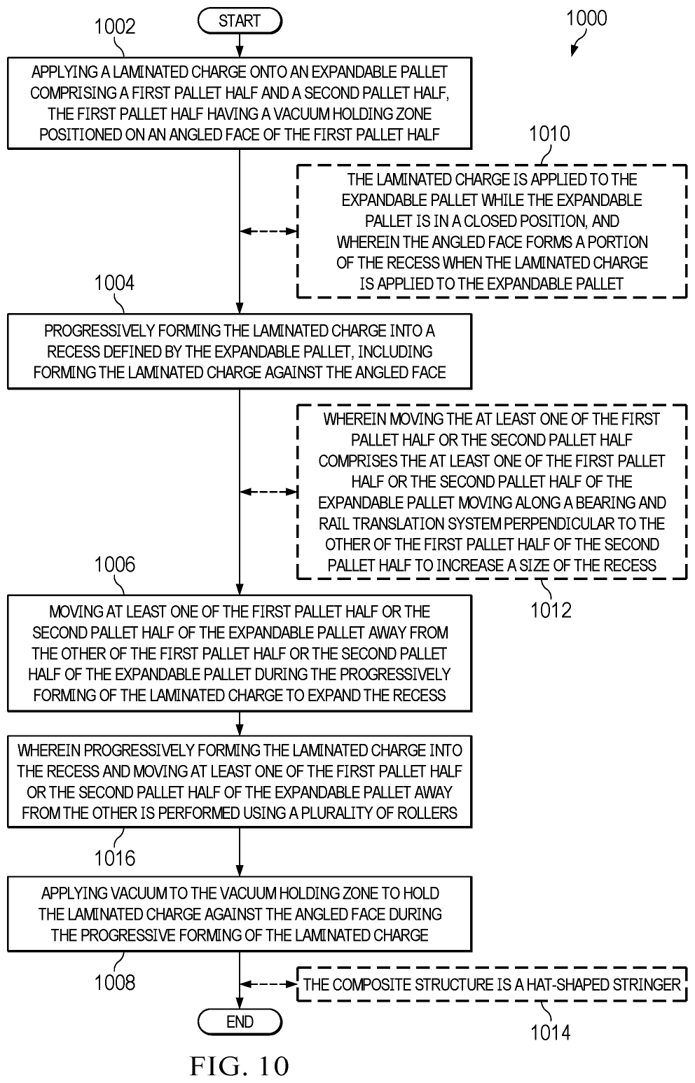

Turning now to FIG. 10, a flowchart of a method of forming a composite structure is depicted in accordance with an illustrative embodiment.

Method 1000 applies a laminated charge onto an expandable pallet comprising a first pallet half and a second pallet half, the first pallet half having a vacuum holding zone positioned on an angled face of the first pallet half (operation 1002). Method 1000 progressively forms the laminated charge into a recess defined by the expandable pallet, including forming the laminated charge against the angled face (operation 1004). Method 1000 moves at least one of the first pallet half or the second pallet half of the expandable pallet away from the other of the first pallet half or the second pallet half of the expandable pallet during the progressively forming of the laminated charge to expand the recess (operation 1006). Method 1000 applies vacuum to the vacuum holding zone to hold the laminated charge against the angled face during the progressive forming of the laminated charge (operation 1008). Afterwards, method 1000 terminates.

In some illustrative examples, the laminated charge is applied to the expandable pallet while the expandable pallet is in a closed position, and wherein the angled face forms a portion of the recess when the laminated charge is applied to the expandable pallet (operation 1010). In some illustrative examples, the first pallet half is in contact with the second pallet half in the closed position. In some illustrative examples, a gap forms between the first pallet half and the second pallet half in moving between the closed position and an open position. In some illustrative examples, moving the at least one of the first pallet half or the second pallet half comprises the at least one of the first pallet half or the second pallet half of the expandable pallet moving along a bearing and rail translation system perpendicular to the other of the first pallet half or the second pallet half to increase a size of the recess (operation 1012).

In some illustrative examples, the composite structure comprises two flanges, two webs, and a hat section. In some illustrative examples, the composite structure is a hat-shaped stringer (operation 1014).

In some illustrative examples, progressively forming the laminated charge into the recess and moving at least one of the first pallet half or the second pallet half of the expandable pallet away from the other is performed using a plurality of rollers (operation 1016). In these illustrative examples, the plurality of rollers incrementally form the laminated charge and incrementally expand the recess in the expandable pallet during the forming.

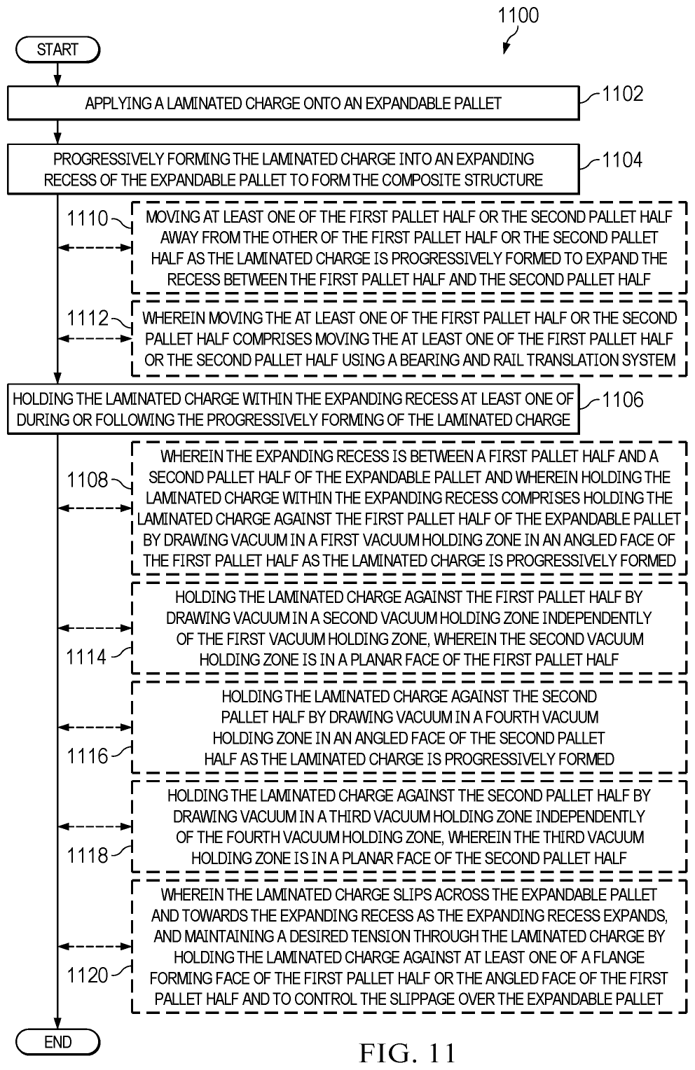

Turning now to FIG. 11, a flowchart of a method of forming a composite structure is depicted in accordance with an illustrative embodiment. Method 1100 can be performed using expandable pallet 206 of FIG. 2. Method 1100 can be performed using expandable pallet 304 of FIG. 3. Method 1100 can be performed using expandable pallet 403 of FIG. 4. Method 1100 can be performed using expandable pallet 503 of FIG. 5. Method 1100 can be performed using expandable pallet 603 of FIG. 6. Method 1100 can be performed using first pallet half 702 of FIG. 7. Method 1100 can be performed using expandable pallet 802 of FIG. 8. Method 1100 can be performed using plurality of rollers 902 relative to expandable pallet 904 of FIG. 9.

Method 1100 applies a laminated charge onto an expandable pallet (operation 1102). Method 1100 progressively forms the laminated charge into an expanding recess of the expandable pallet to form the composite structure (operation 1104). Method 1100 holds the laminated charge within the expanding recess at least one of during or following the progressively forming of the laminated charge (operation 1106). Afterwards, method 1100 terminates.

In some illustrative examples, the expanding recess is between a first pallet half and a second pallet half of the expandable pallet and wherein holding the laminated charge within the expanding recess comprises holding the laminated charge against the first pallet half of the expandable pallet by drawing vacuum in a first vacuum holding zone in an angled face of the first pallet half as the laminated charge is progressively formed (operation 1108).

In some illustrative examples, method 1100 moves at least one of the first pallet half or the second pallet half away from the other of the first pallet half or the second pallet half to expand the recess between the first pallet half and the second pallet half as the laminated charge is progressively formed (operation 1110). In some illustrative examples, moving the at least one of the first pallet half or the second pallet half comprises moving the at least one of the first pallet half or the second pallet half using a bearing and rail translation system (operation 1112).

In some illustrative examples, method 1100 holds the laminated charge against the first pallet half by drawing vacuum in a second vacuum holding zone independently of the first vacuum holding zone, wherein the second vacuum holding zone is in a planar face of the first pallet half (operation 1114). In some illustrative examples, the second vacuum holding zone is present in a flange forming surface of the first pallet half. In some illustrative examples, the first vacuum holding zone is present in a web forming surface of the first pallet half.

In some illustrative examples, method 1100 holds the laminated charge against the second pallet half by drawing vacuum in a fourth vacuum holding zone in an angled face of the second pallet half as the laminated charge is progressively formed (operation 1116). In some illustrative examples, method 1100 holds the laminated charge against the second pallet half by drawing vacuum in a third vacuum holding zone independently of the fourth vacuum holding zone, wherein the third vacuum holding zone is in a planar face of the second pallet half (operation 1118).

In some illustrative examples, the laminated charge slips across the expandable pallet and towards the expanding recess as the expanding recess expands, and method 1100 further comprises maintaining a desired tension through the laminated charge by holding the laminated charge against at least one of a flange forming face of the first pallet half or the angled face of the first pallet half and to control slippage over the expandable pallet (operation 1120). In these illustrative examples, tension is maintained through the laminated charge by holding the laminated charge against the flange and web forming faces. In some illustrative examples, the tension is maintained by applying vacuum by multiple vacuum holding zones.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1010 through operation 1014 may be optional. For example, operation 1108 through operation 1116 may be optional. For example, operation 1102 through operation 1008 may be optional.

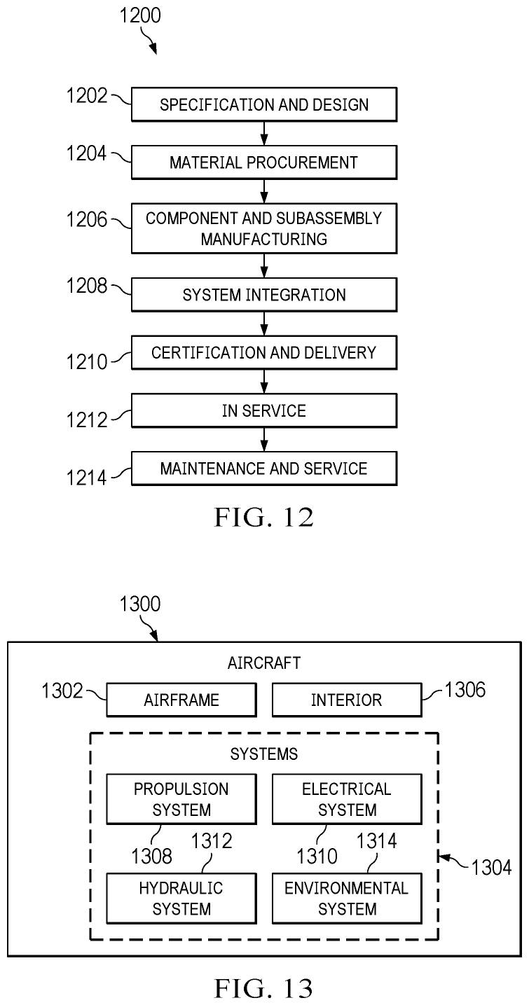

Illustrative embodiments of the present disclosure may be described in the context of aircraft manufacturing and service method 1200 as shown in FIG. 12 and aircraft 1300 as shown in FIG. 13. Turning first to FIG. 12, an illustration of an aircraft manufacturing and service method in a form of a block diagram is depicted in accordance with an illustrative embodiment. During pre-production, aircraft manufacturing and service method 1200 may include specification and design 1202 of aircraft 1300 in FIG. 13 and material procurement 1204.

During production, component and subassembly manufacturing 1206 and system integration 1208 of aircraft 1300 takes place. Thereafter, aircraft 1300 may go through certification and delivery 1210 in order to be placed in service 1212. While in service 1212 by a customer, aircraft 1300 is scheduled for routine maintenance and service 1214, which may include modification, reconfiguration, refurbishment, or other maintenance and service.

Each of the processes of aircraft manufacturing and service method 1200 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 13, an illustration of an aircraft in a form of a block diagram is depicted in which an illustrative embodiment may be implemented. In this example, aircraft 1300 is produced by aircraft manufacturing and service method 1200 of FIG. 12 and may include airframe 1302 with plurality of systems 1304 and interior 1306. Examples of systems 1304 include one or more of propulsion system 1308, electrical system 1310, hydraulic system 1312, and environmental system 1314. Any number of other systems may be included.

Apparatuses and methods embodied herein may be employed during at least one of the stages of aircraft manufacturing and service method 1200. One or more illustrative embodiments may be manufactured or used during at least one of component and subassembly manufacturing 1206, system integration 1208, in service 1212, or maintenance and service 1214 of FIG. 12.

The illustrative examples present an expandable pallet for forming composite structures. An expandable pallet is configured for forming hat shaped composite stringers. The illustrative examples comprise vacuum holding zones in the web areas of the composite structure to hold the stringer shape after forming. The illustrative examples lock the expandable pallet position after forming.

The vacuum holding zones in the angled faces and locked expandable pallet position allow a composite stricture to hold its shape without relaxing with a reduced forming time. The illustrative examples enable a faster stringer fabrication process. The expandable pallet can be used with a punch forming process or a wedge roller forming process.

In some illustrative examples, a secondary vacuum source and secondary vacuum zone are present in a pallet half of an expandable pallet. The other feature needed is a pallet position locking mechanism and a method for that lock to be unlocked during forming and locked once the final forming process has taken place. The illustrative examples provide ball bearing trucks and rails paired with an air cylinder for a system that can be more precisely aligned and manipulated.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An expandable pallet for forming a composite structure comprising:
a first pallet half having a vacuum holding zone positioned on an angled face of the first pallet half; and
a second pallet half movable relative to the first pallet half to expand a recess between the first pallet half and the second pallet half for forming the composite structure, the recess comprising the angled face of the first pallet half.

2. The expandable pallet of claim 1, wherein the vacuum holding zone positioned on the angled face of the first pallet half is a first vacuum holding zone, and wherein the first pallet half comprises the first vacuum holding zone and a second vacuum holding zone controllable independently of the first vacuum holding zone.

3. The expandable pallet of claim 2, wherein the second vacuum holding zone is positioned on a flange forming face of the first pallet half.

4. The expandable pallet of claim 2, wherein the second pallet half has a third vacuum holding zone and a fourth vacuum holding zone controllable independently of the third vacuum holding zone, wherein the fourth vacuum holding zone is positioned on an angled face of the second pallet half.

5. The expandable pallet of claim 4, wherein the first vacuum holding zone forms a first web portion of a stringer and the fourth vacuum holding zone forms a second web portion of the stringer.

6. The expandable pallet of claim 1, wherein the first pallet half comprises an interfacing surface and the second pallet half comprises a second interfacing surface, wherein the interfacing surface and the second interfacing surface are in contact with each other when the expandable pallet is in a closed position.

7. The expandable pallet of claim 1 further comprising:
a bearing and rail translation system, wherein the first pallet half and the second pallet half are movably connected to the bearing and rail translation system.

8. The expandable pallet of claim 1 further comprising:
a number of pressure regulators connected to at least one of first pallet half or the second pallet half and configured to resist outward movement during forming and lock in place when forming of a laminated charge is complete.

9. The expandable pallet of claim 1 further comprising:
a support movable in between the first pallet half and the second pallet half and configured to contact a portion of a laminated charge extending between the first pallet half and the second pallet half.

10. The expandable pallet of claim 9, wherein a fifth vacuum holding zone is present in the support, wherein the fifth vacuum holding zone is independently controllable.

11. A method of forming a composite structure, the method comprising:
applying a laminated charge onto an expandable pallet comprising a first pallet half and a second pallet half, the first pallet half having a vacuum holding zone positioned on an angled face of the first pallet half;
progressively forming the laminated charge into a recess defined by the expandable pallet, including forming the laminated charge against the angled face; and
moving at least one of the first pallet half or the second pallet half of the expandable pallet away from the other of the first pallet half or the second pallet half of the expandable pallet during the progressively forming of the laminated charge to expand the recess; and
applying vacuum to the vacuum holding zone to hold the laminated charge against the angled face during the progressive forming of the laminated charge.

12. The method of claim 11, wherein the composite structure is a hat-shaped stringer.

13. The method of claim 11, wherein the laminated charge is applied to the expandable pallet while the expandable pallet is in a closed position, and wherein the angled face forms a portion of the recess when the laminated charge is applied to the expandable pallet.

14. The method of claim 11, wherein moving the at least one of the first pallet half or the second pallet half comprises the at least one of the first pallet half or the second pallet half moving along a bearing and rail translation system perpendicular to the other of the first pallet half or the second pallet half to increase a size of the recess.

15. The method of claim 11, wherein progressively forming the laminated charge into the recess and moving at least one of the first pallet half or the second pallet half of the expandable pallet away from the other is performed using a plurality of rollers.

16. A method of forming a composite structure, the method comprising:
applying a laminated charge onto an expandable pallet;
progressively forming the laminated charge into an expanding recess of the expandable pallet to form the composite structure; and
holding the laminated charge within the expanding recess at least one of during or following the progressively forming of the laminated charge.

17. The method of claim 16, wherein the expanding recess is between a first pallet half and a second pallet half of the expandable pallet, and wherein holding the laminated charge within the expanding recess comprises holding the laminated charge against the first pallet half of the expandable pallet by drawing vacuum in a first vacuum holding zone in an angled face of the first pallet half as the laminated charge is progressively formed.

18. The method of claim 17, wherein the laminated charge slips across the expandable pallet and towards the expanding recess as the expanding recess expands, and further comprising:
maintaining a desired tension through the laminated charge by holding the laminated charge against at least one of a flange forming face of the first pallet half or the angled face of the first pallet half and to control slippage over the expandable pallet.

19. The method of claim 17 further comprising:
holding the laminated charge against the first pallet half by drawing vacuum in a second vacuum holding zone independently of the first vacuum holding zone, wherein the second vacuum holding zone is in a planar face of the first pallet half.

20. The method of claim 17 further comprising:
holding the laminated charge against the second pallet half by drawing vacuum in a fourth vacuum holding zone in an angled face of the second pallet half as the laminated charge is progressively formed.

21. The method of claim 20 further comprising:
holding the laminated charge against the second pallet half by drawing vacuum in a third vacuum holding zone independently of the fourth vacuum holding zone, wherein the third vacuum holding zone is in a planar face of the second pallet half.

22. The method of claim 17 further comprising:
moving at least one of the first pallet half or the second pallet half away from the other of the first pallet half or the second pallet half to expand the recess between the first pallet half and the second pallet half as the laminated charge is progressively formed.

23. The method of claim 22, wherein moving the at least one of the first pallet half or the second pallet half comprises moving the at least one of the first pallet half or the second pallet half using a bearing and rail translation system.
